(19) United States
(12) Patent Application Publication
(10) Pub. No.: US 2020/0380540 A1
(43) Pub. Date: Dec. 3, 2020

(54) PREDICTING THE PROBABILITY OF A PRODUCT PURCHASE

(71) Applicant: HG Insights, Inc., Santa Barbara, CA (US)

(72) Inventors: Robert J. Fox, Santa Barbara, CA (US); Samuel B. Chapin, Santa Barbara, CA (US); Xining Li, Goleta, CA (US)

(21) Appl. No.: 16/427,282

(22) Filed: May 30, 2019

(51) Int. Cl. G06Q 30/02; G06N 20/00; G06F 17/16

(52) U.S. Cl. CPC G06Q 30/0202; G06F 17/16; G06N 20/00

(57) ABSTRACT

The probability that an entity will purchase a product is predicted. This prediction involves receiving input data in the form of entries each of which represents an interest event. Through a series of iterations, a final matrix is generated from the input data entries by assigning an entity-product identifier pair associated with each interest event to a different location in the matrix, along with a time identifier indicative of how far back in time the interest event occurred from a prescribed date of interest. A supervised machine learning technique is employed to create a final prediction model for each product of interest using the final matrix as input. For each product, its prediction model is applied to the input data to estimate the probability that an entity will purchase the product within a future time period.

### BACKGROUND

Advertisers, product manufacturers and technology vendors continually seek ways to identify potential customers who may purchase their products in the near future. This allows these entities to better target potential customers. The better the method of identifying these customers, the better the results. For example, blanket advertisements and blind contacts are less efficient, more costly and often less effective than targeted advertisements to potential customer who are believed to have an interest in purchasing a product. Ultimately, having knowledge of who is more likely to buy a product leads to more sales.

### SUMMARY

Product purchase probability prediction implementations (or purchase prediction implementations for short) described herein generally predict the probability that an entity will purchase a product (or a product from a category of products) within a period of time in the near future. One exemplary implementation takes the form of a system for predicting the probability that an entity will purchase a product within a future time period. This system includes a purchase probability predictor having one or more computing devices, and a purchase probability prediction computer program having a plurality of sub-programs executable by the computing device or devices. The sub-programs configure the computing device or devices to first receive input data in the form of entries. Each entry includes an entity identifier that identifies an entity that is a potential purchaser of a product, a product identifier that identifies a product that the entity associated with the entity identifier might purchase based on an interest event that is indicative of the product being relevant to the entity, a time period identifier that specifies a past time period measured backward from a prescribed date of interest to an interest event date corresponding to the date the interest event associated with the entry occurred, and an intensity value indicative of the degree to which the product associated with the product identifier is deemed relevant to the entity associated with the entity identifier. Another sub-program generates a matrix from a portion of the input data entries. This matrix generation includes assigning an entity identifier and product identifier pair associated with each interest event to a different location in the matrix, along with a time identifier indicative of how far back in time the interest event associated with each entity-product identifier pair occurred from the prescribed date of interest. A sub-program then employs a supervised machine learning technique to create a separate initial prediction model for each product of interest in the input data using the matrix as input. Each initial prediction model estimates the probability that an entity in the input data will purchase the product associated with the model. Another sub-program then generates a final matrix from the input data entries. This entails assigning an entity identifier and product identifier pair associated with each interest event to a different location in the matrix, along with a time identifier indicative of how far back in time the interest event associated with each entity-product identifier pair occurred from the prescribed date of interest. Next, using the final matrix and control parameters established in creating the initial prediction model for each product as input, a sub-program employs the supervised machine learning technique to create a separate final prediction model for each product of interest in the input data that estimates the probability that an entity in the input data will purchase the product within the future time period. A sub-program then uses the input data and, for each product, applies the finalized prediction model associated with that product to estimate the probability that an entity will purchase the product within the future time period. This is followed by a sub-program establishing a list of entities, the products they are predicted to purchase and the probability of the purchases.

Another exemplary implementation takes the form of a system for predicting the probability that an entity will purchase a product form a category of products within a future time period. This system includes a purchase probability predictor having one or more computing devices, and a purchase probability prediction computer program having a plurality of sub-programs executable by the computing device or devices. The sub-programs configure the computing device or devices to first receive input data in the form of entries. Each entry includes an entity identifier that identifies an entity that is a potential purchaser of a product, a product category identifier that identifies a category of products that includes a product that the entity associated with the entity identifier might purchase based on an interest event that is indicative of the product category being relevant to the entity, a time period identifier that specifies a past time period measured backward from a prescribed date of interest to an interest event date corresponding to the date the interest event associated with the entry occurred, and an intensity value indicative of the degree to which the product category associated with the product category identifier is deemed relevant to the entity associated with the entity identifier. Another sub-program generates a matrix from a portion of the input data entries. This matrix generation includes assigning an entity identifier and product category identifier pair associated with each interest event to a different location in the matrix, along with a time identifier indicative of how far back in time the interest event associated with each entity-product category identifier pair occurred from the prescribed date of interest. A sub-program then employs a supervised machine learning technique to create a separate initial prediction model for each product category of interest in the input data using the matrix as input. Each initial prediction model estimates the probability that an entity in the input data will purchase a product in the product category associated with the model. Another sub-program then generates a final matrix from the input data entries. This entails assigning an entity identifier and product category identifier pair associated with each interest event to a different location in the matrix, along with a time identifier indicative of how far back in time the interest event associated with each entity-product category identifier pair occurred from the prescribed date of interest. Next, using the final matrix and control parameters established in creating the initial prediction model for each product category as input, a sub-program employs a supervised machine learning technique to create a separate final prediction model for each product category of interest in the input data that estimates the probability that an entity in the input data will purchase a product in the product category within the future time period. A sub-program then uses the input data and, for each product category, applies the finalized prediction model associated with that product category to estimate the probability that an entity will purchase a product in the product category within the future time period. This is followed by a sub-program establishing a list of entities, the product categories they are predicted to purchase products from and the probability of the purchases.

One exemplary implementation takes the form of a computer-implemented process for predicting the probability that an entity will purchase a product within a future time period. This process uses one or more computing devices to perform a number of process actions. If a plurality of computing devices is employed, the computing devices are in communication with each other via a computer network. A first of the process actions involves receiving input data in the form of entries. Each entry includes an entity identifier that identifies an entity that is a potential purchaser of a product, a product identifier that identifies a product that the entity associated with the entity identifier might purchase based on an interest event that is indicative of the product being relevant to the entity, a time period identifier that specifies a past time period measured backward from a prescribed date of interest to an interest event date corresponding to the date the interest event associated with the entry occurred, and an intensity value indicative of the degree to which the product associated with the product identifier is deemed relevant to the entity associated with the entity identifier. Another process action generates a matrix from a portion of the input data entries. This matrix generation includes assigning an entity identifier and product identifier pair associated with each interest event to a different location in the matrix, along with a time identifier indicative of how far back in time the interest event associated with each entity-product identifier pair occurred from the prescribed date of interest. A process action is included to employ a supervised machine learning technique to create a separate initial prediction model for each product of interest in the input data using the matrix as input. Each initial prediction model estimates the probability that an entity in the input data will purchase the product associated with the model. Another process action then generates a final matrix from the input data entries. This entails assigning an entity identifier and product identifier pair associated with each interest event to a different location in the matrix, along with a time identifier indicative of how far back in time the interest event associated with each entity-product identifier pair occurred from the prescribed date of interest. Next, using the final matrix and control parameters established in creating the initial prediction model for each product as input, a process action employs a supervised machine learning technique to create a separate final prediction model for each product of interest in the input data that estimates the probability that an entity in the input data will purchase the product within the future time period. A process action is included to then use the input data and, for each product, apply the finalized prediction model associated with that product to estimate the probability that an entity will purchase the product within the future time period. This is followed by a process action establishing a list of entities, the products they are predicted to purchase and the probability of the purchases.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the purchase prediction implementations described herein will become better understood with regard to the following description, appended claims, and accompanying drawings where:

FIG. 1 is a diagram illustrating one implementation, in simplified form, of a system framework for realizing the purchase prediction implementations described herein.

FIG. 2 is a diagram illustrating one implementation, in simplified form, of the sub-programs included in the purchase probability prediction computer program.

FIG. 3 is an example listing of a few input data entries.

FIGS. 4A-B are a flow diagram illustrating an exemplary implementation, in simplified form, of a process for predicting the probability that an entity will purchase a product within a future time period.

FIGS. 5A-B are a flow diagram illustrating an exemplary implementation, in simplified form, of a process for generating a matrix.

FIGS. 6A-B are a flow diagram illustrating an exemplary implementation, in simplified form, of a process for generating a final matrix.

FIG. 7 is a flow diagram illustrating an exemplary implementation, in simplified form, of a process for eliminating the input data entries deemed likely to be inaccurate prior to generating the first matrix.

FIG. 8 is a diagram illustrating a simplified example of a general-purpose computer system on which various implementations and elements of the purchase prediction technique, as described herein, may be realized.

### DETAILED DESCRIPTION

In the following description of purchase prediction implementations reference is made to the accompanying drawings which form a part hereof, and in which are shown, by way of illustration, specific implementations in which the purchase prediction can be practiced. It is understood that other implementations can be utilized and structural changes can be made without departing from the scope of the purchase prediction implementations.

It is also noted that for the sake of clarity specific terminology will be resorted to in describing the purchase prediction implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “some implementations”, or “one tested implementation”; or “one version”, or “another version”, or an “exemplary version”, or an “alternate version”, or “some versions”, or “one tested version”; or “one variant”, or “another variant”, or an “exemplary variant”, or an “alternate variant”, or “some variants”, or “one tested variant”; means that a particular feature, a particular structure, or particular characteristics described in connection with the implementation/version/variant can be included in one or more implementations of the purchase prediction. The appearances of the phrases “in one implementation”, “in another implementation”, “in an exemplary implementation”, “in an alternate implementation”, “in some implementations”, “in one tested implementation”; “in one version”, “in another version”, “in an exemplary version”, “in an alternate version”, “in some versions”, “in one tested version”; “in one variant”, “in another variant”, “in an exemplary variant”, “in an alternate variant”, “in some variants” and “in one tested variant”; in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the purchase prediction does not inherently indicate any particular order nor imply any limitations of the purchase prediction.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive, in a manner similar to the term “comprising”, as an open transition word without precluding any additional or other elements.

### 1.0 Product Purchase Probability Prediction

Product purchase probability prediction implementations (or purchase prediction implementations for short) that are described herein generally predict the probability that an entity will purchase a product (or a product from a category of products) within a period of time in the near future. It is noted that for the purposes of this description, the definition of the term “product” used in economics will be adopted in that this term includes both tangible and intangible goods as well as services. Thus, for example, investment advice can be deemed a product of a brokerage company. With regard to the distinction between the purchase of a product or a purchase of a product from a category of products, purchase prediction implementations described herein can be designed to predict the purchase of a particular product. For example, but without limitation, it can be predicted that an entity will purchase a particular model of laserjet printer from a particular manufacturer. Alternatively, purchase prediction implementations described herein can be tailored to predict that an entity will purchase a product from a category of products. For example, but without limitation, it can be predicted that an entity will purchase a printer (i.e., a category of products), but the prediction does not specify what model of printer. For the purposes of the description to follow, whenever a product is mentioned, it is understood that the product can be a product category instead. Additionally, for the purposes of this description, an entity can refer to a natural entity such as an individual person; a business entity such as an association, corporation, partnership, company, proprietorship, or trust; or a governmental entity such as a university or institute; among others.

Purchase prediction implementations described herein are advantageous for various reasons including, but not limited to, the following. For example, the purchase prediction implementations described herein provide a more accurate prediction because a statistical likelihood approach is used instead of a more typical relationship-based scoring approach. In addition, rather than simply focusing on purchases made in the past by various entities, a broader scope is employed. As will be described in more detail in the paragraphs to follow, the input data revolves around “interest events”, which can be any communication by an entity about a product, or even some mention of an entity and a product by a third party. These communications need not involve the purchase of a product to qualify as an interest event.

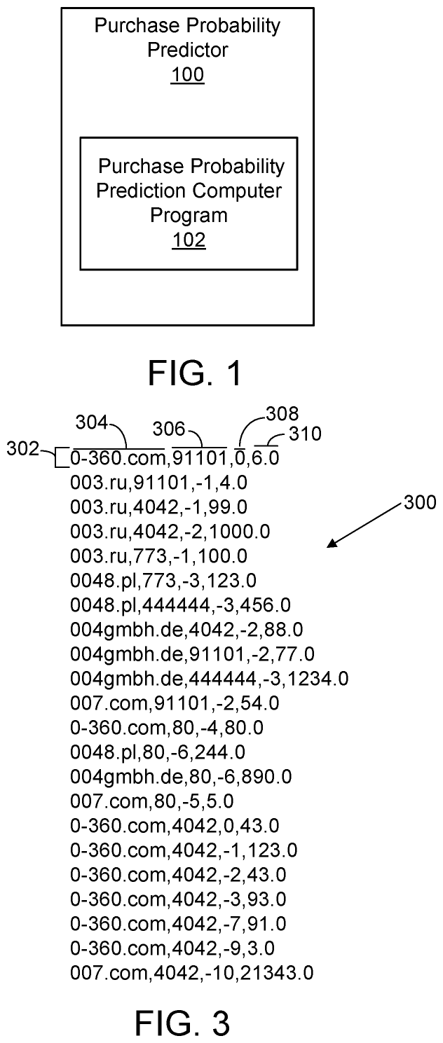

FIG. 1 illustrates one implementation, in simplified form, of a system framework for realizing the purchase prediction implementations described herein. As exemplified in FIG. 1, the system framework includes a purchase probability predictor including one or more computing devices 100, and a purchase probability prediction computer program 102 having a plurality of sub-programs executable by the computing device or devices of the predictor.

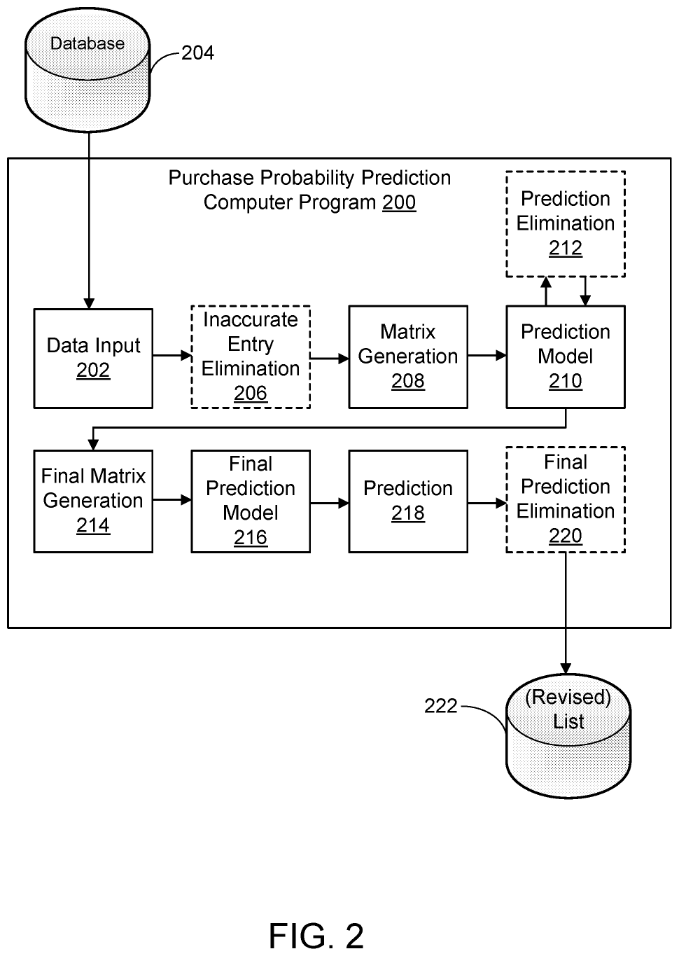

FIG. 2 illustrates one implementation, in simplified form, of the sub-programs included in the purchase probability prediction computer program 200 that configure the aforementioned computing device or devices. More particularly, a data input sub-program 202 is included as shown in FIG. 2. The data input sub-program receives input data form a database 204. In one implementation, the input data is in the form of 4-component entries. Each entry includes an entity identifier, a product identifier, a time period identifier and an intensity value.

The entity identifier identifies an entity that is a potential purchaser. This purchase can be of a specific product, or in an alternative implementation any product from a category of products.

The product identifier identifies a product that the entity associated with the entity identifier might purchase based on an interest event that is indicative of the product being relevant to the entity. The product identified can be a specific product, such as one having a unique model number and made by a particular manufacturer. Alternatively, the product identifier can identify a product category that includes multiple products. In one implementation, an interest event that is indicative of a product being relevant to the entity includes the entity expressing an interest in the product in a communication. For example, an interest event can be a communication that indicates an entity bought a product, or inquired about a product, or even just mentions a product. In another implementation, an interest event that is indicative of a product being relevant to the entity includes a third party mentioning the entity and the product in a communication.

The time period identifier specifies a past time period measured backward from a prescribed date of interest to an interest event date corresponding to the date the interest event associated with the entry occurred. The prescribed date of interest is decided upon ahead of time and can represent the then current date, or some other date of interest such as the date the input data was compiled or the most recent date found in the input data. In one implementation, the time period identifier is a “Days Ago” value that specifies the number of days back from a prescribed date that an interest event occurred. It is noted that the measure of time need not be a day as in the foregoing example. It could be hours or weeks instead, or whatever time unit that makes sense for the interest events being considered.

Each entry further includes an intensity value. This intensity value is indicative of the degree to which the product associated with the entry's product identifier is deemed relevant to the entity associated with the entity identifier. For example, in one implementation, the intensity value corresponds to the number of times an interest event associated with an entity and a product occurred over a prescribed period of time prior to the aforementioned prescribed date.

FIG. 3 shows an example list 300 of a few input data entries 302. It is noted that an actual input data list could contain thousands of entries like those shown in FIG. 3. In the list depicted, each line is a separate entry. The four values in each line demarcated by commas correspond to the entity identifier 304, product identifier 306, time period identifier 308 and intensity values 310 in that order from left to right. As can be seen in FIG. 3, the entity identifiers 304 (e.g., 0-360.com) are url-based and each uniquely identifies a different entity. The product identifier 306 shown in the example list is a numerical representation of a product that uniquely identifies that particular product. The time period identifier 308 in this example is a negative integer representing how many days back from the aforementioned prescribed date that the interest event associated with the entity occurred. And finally, the intensity value is this example is a numerical representation of the degree of relevance the product has to the entity.

Referring again to FIG. 2, the purchase probability prediction computer program 200 can optionally include an inaccurate entry elimination sub-program 206 for identifying and removing entries that are deemed likely to be inaccurate. The optional nature of this sub-program is reflected in FIG. 2 by a dashed-line box. In one implementation, a Seasonal Extreme Studentized Deviate (Seasonal ESD) test is used to identify outlier entries in the input based on the time period identifiers and intensity values. This test requires a prescribed significance level to be set. In one tested implementation, a significance level of 0.05 was employed for the Seasonal ESD test with satisfactory results. Outlier entries are considered to be more likely to be inaccurate and are eliminated from the input data as long as a prescribed percentage of the entries have not already been removed. In one tested implementation, it was found that setting the maximum percentage of the entries that would be removed to 10 percent provided satisfactory results. One advantage of eliminating potentially inaccurate entries at this stage of the sub-program is to reduce the amount of computer processing that would otherwise have to be expended to analyze these entries. In addition, it has been found that the overall accuracy of the predicted purchases is increased when potentially inaccurate entries are removed from the input data.

Referring again to FIG. 2, the purchase probability prediction computer program 200 also includes a matrix generation sub-program 208. The sub-program 208 first generates a “first seen data” listing from input data. In one implementation, this involves removing the intensity measure term from each of the entries in the input data. The first seen data is next used to generate a 2-D matrix where each location in the matrix corresponds to an entity-product pair associated with a different interest event. More particularly, the matrix generation sub-program 208 generates a matrix from a portion of the first seen data entries by assigning an entity identifier and product identifier pair associated with each interest event to a different location in the matrix, along with a time identifier indicative of how far back in time the interest event associated with each entity-product identifier pair occurred from the aforementioned prescribed date of interest. Thus, multiple matrix locations could be assigned the same company-product pair but would be associated with a different interest event. The matrix advantageously puts the input data into a form that can be more efficiently stored and accessed.

In one implementation, the above-described matrix is constructed as follows. Each input data entry is first mapped onto a timeline based on the entry's time period identifier. The resulting timeline is then split so that a prescribed percentage of the entries closest to the prescribed date of interest are designated as test entries and the remaining entries are designated as training entries. In one implementation, the timeline is split so that 30% of the entries closest to the prescribed date of interest are designated as test entries and the remaining 70% of the entries are designated as training entries. It was empirically found that this split produced satisfactory results based on an analysis of prediction performance. However, it is not intended to limit the purchase prediction implementations described herein to this specific split as other percentages might produce more accurate predictions dependent on the nature of the input data.

For the portion of the timeline designated as training entries, a time window of a prescribed size is stepped over the timeline starting at the time corresponding to the mapped entry having largest time period identifier (i.e., the oldest entry) and moving forward in time a prescribed stride amount with each successive step. In one tested implementation, a time window of 200 days and a stride amount of 200 days were used with satisfactory results on a 500-day training portion of the timeline. However, it is not intended that the size of the timeline's training portion, or the size of the time window, or the stride amount be limited to the foregoing values. Other values may produce better results depending on the characteristics of the input data. At each step of the time window, an entity identifier and product identifier pair is created for each entry mapped onto the timeline that falls within the current time window and assigned to the matrix as long as a pair associated with the same interest event is not already in the matrix. A time window identifier associated with the current time window step is assigned to the created pair if an entity identifier and product identifier pair corresponding to the same interest event as the created pair is not already assigned to a location in the matrix. If an entity identifier and product identifier pair corresponding to the same interest event as the created pair is already assigned to a location in the matrix, the time window identifier associated with the current time window step is instead assigned to the entity identifier and product identifier pair corresponding to the same interest event as the created pair. In other words, for each successive time window (which can overlap the immediately preceding window) that contains an entity-product pair associated with the same interest event as a preceding window, the existing element in the matrix for that pair is assigned the new window identifier rather than establishing a new location in the matrix. It is noted that in one implementation each created pair assigned to the matrix is assigned to a different location. This continues with each step of the time window until the time associated with the split is encountered. As such, the matrix only captures the training portion of the timeline and not the test portion.

Referring once again to FIG. 2, the purchase probability prediction computer program 200 further includes a prediction model sub-program 210. In one implementation, the sub-program 210 employs a supervised machine learning technique to create a separate prediction model for each product of interest in the input data using the matrix data as input. These models estimate the probability that an entity in the input data will purchase the product (or a product in a product category) associated with the model within a prescribed future period of time. In one version, the supervised machine learning technique employed is a logistic regression technique with elastic net regularization (e.g., one using Ridge and LASSO regression), as available from H₂O.ai. However, it is not intended to limit the purchase prediction implementations described herein to just this technique or even other supervised machine learning techniques. Rather any appropriate artificial intelligence method can be employed to generate a prediction model for each product.

In the version of the prediction model sub-program 210 employing logistic regression with elastic net regularization, for each product, the matrix data associated with that product is input into the regression analysis to produce an initial prediction model. In is noted that a response vector is also input into the regression analysis. This response vector is derived from the testing portion of the timeline and represents an entity-product list for products of interest that were purchased in the timeframe associated with the testing portion of the timeline. The initial model is developed in an iterative process that models the aforementioned training region of the timeline and generally validates it by comparing the predicted purchases for the applicable product against actual purchases found in the aforementioned testing region of the timeline. More particularly, this modeling process is a cross validation scheme where one or more control parameters are initially selected and iteratively modified to lead to a maximization of the accuracy of the model over the course of the iterations. For example, in one tested implementation where a coordinate descent scheme is employed in the regression analysis, a control parameter “alpha” is initially set to 0.6 and the lambda value is unset and automatically determined. In another tested implementation, a L-BGFS (Limited Memory Broyden-Fletcher-Goldfarb-Shanno) solver was employed in the regression analysis. In this implementation, the control parameter alpha is initially set to 0.6 and a “lambda” value is initially set to 0.00001. However, it is not intended that the purchase prediction implementations described herein be limited to these types of solvers. Depending on the nature of the input data (e.g., large/medium/small number of products) other solvers may be employed. Finally, the resulting prediction model is designated as the initial prediction model for the product.

Referring again to FIG. 2, the purchase probability prediction computer program 200 can further include an optional prediction elimination sub-program 212. The optional nature of this sub-program is once again reflected by the use of a broken-line box in FIG. 2. In one implementation, the optional prediction elimination involves eliminating unlikely predictions during the initial model validation process. The prediction elimination is employed to ignore purchase predictions for entities that are not likely based on known data. For example, if it is known that an entity has already purchased or licensed a product, or a similar product in the same product category, it is less likely that they would purchase or license this product in the near future. Thus, any predicted purchase of the product by that company would be ignored during the initial model validation process.

Referring once again to FIG. 2, the purchase probability prediction computer program 200 further includes a final matrix generation sub-program 214. The previously described first seen data (which may have been “de-noised”) is used to generate a 2-D matrix where each location in the matrix corresponds to an entity-product pair associated with a different interest event. This matrix is constructed as described previously, except that instead of just the training data being used, the final matrix is constructed using all the first seen data.

More particularly, the final matrix generation sub-program 214 generates a final matrix from all the first seen data entries (less any optionally removed using the previously-described de-noising scheme) by assigning an entity identifier and product identifier pair associated with each interest event to a different location in the matrix, along with a time identifier indicative of how far back in time the interest event associated with each entity-product identifier pair occurred from the aforementioned prescribed date of interest. In one implementation, the above-described final matrix is constructed as follows. Each input data entry is first mapped onto a timeline based on the entry's time period identifier. A time window of a prescribed size is stepped over the timeline starting at the time corresponding to the mapped entry having largest time period identifier (i.e., the oldest entry) and moving forward in time a prescribed stride amount with each successive step. In one tested implementation, the time window size and stride amount were the same as used to generate the previous matrix. At each step of the time window, an entity identifier and product identifier pair is created for each entry mapped onto the timeline that falls within the current time window step and assigned to the matrix as long as a pair associated with the same interest event has not already in the matrix. A time window identifier associated with the current time window step is assigned to the created pair if an entity identifier and product identifier pair corresponding to the same interest event as the created pair is not already assigned to a location in the matrix. If an entity identifier and product identifier pair corresponding to the same interest event as the created pair is already assigned to a location in the matrix, the time window identifier associated with the current time window step is instead assigned to the entity identifier and product identifier pair corresponding to the same interest event as the created pair. It is noted that as before each created pair assigned to the matrix is assigned to a different location. This continues with each step of the time window until the end of the timeline is reached.

The purchase probability prediction computer program 200 further includes a final prediction model sub-program 216. In one implementation, the sub-program 216 employs a supervised machine learning technique to create a separate prediction model for each product of interest in the input data using the final matrix data as input. These models estimate the probability that an entity in the input data will purchase the product (or a product in a product category) associated with the final model within a prescribed future period of time. In one version, the supervised machine learning technique employed is a logistic regression technique with elastic net regularization (e.g., one using Ridge and LASSO regression) as available from H₂O.ai. However, it is not intended to limit the purchase prediction implementations described herein to just this technique or even other supervised machine learning techniques. Rather any appropriate artificial intelligence method can be employed to generate a prediction model for each product, although in one version the artificial intelligence method employed to generate the previous prediction models is used to generate the initial prediction model. In the version of the prediction model sub-program 216 employing logistic regression with elastic net regularization, for each product, the final matrix data associated with that product is input into the regression analysis to produce the final prediction model. This final prediction model generation employs the final control parameters established during the process of creating the initial model for the product. No validation of the final prediction model is performed.

Referring again to FIG. 2, the purchase probability prediction computer program 200 includes a prediction sub-program 218. In general, each final prediction model is then used to predict what entities will purchase the applicable product (or product in the applicable category) within a future time period after the aforementioned prescribed date by applying the model to the aforementioned input data to establish a list 220 of entities, the products they are predicted to purchase (or products categories they are predicted to purchase products from) and the probability of the purchases. In one version, the prescribed future period of time is a period of time extending into the future from the aforementioned prescribed date for a length of time equal to 200 days.

Referring once more to FIG. 2, the purchase probability prediction computer program 200 can further include an optional final prediction elimination sub-program 220. Here again, the optional nature of this sub-program is reflected by the use of a broken-line box in FIG. 2. In one implementation, the optional final prediction elimination involves eliminating probability estimates for entities that are known to already have the product to establish a revised list 222 listing entities, the products they are predicted to purchase (or products categories they are predicted to purchase products from) and the probability of the purchases. The prediction elimination is employed to remove purchase probability estimates for entities that are not likely based on known data. For example, if it is known that an entity has already purchased or licensed a product, or a similar product in the same product category, it is less likely that they would purchase or license this product in the near future.

It is noted that different prediction lists can be generated based on the purchase probabilities. For example, a list of only those companies that have a purchase probability of 90% or more could be generated—or a list of companies with at least a 50% purchase probability, or a list of companies with at least a 10% purchase probability. These different lists would have value depending on the application. For instance, if the intent is to push advertisements for the product to companies predicted to purchase the product, it would make sense to use the “10%” list since the cost to send such advertisements can be relatively low. Whereas, if the list is intended to be used to schedule presentations or sales visits, it may be better to employ the “90%” list to keep costs down and maximize sales.

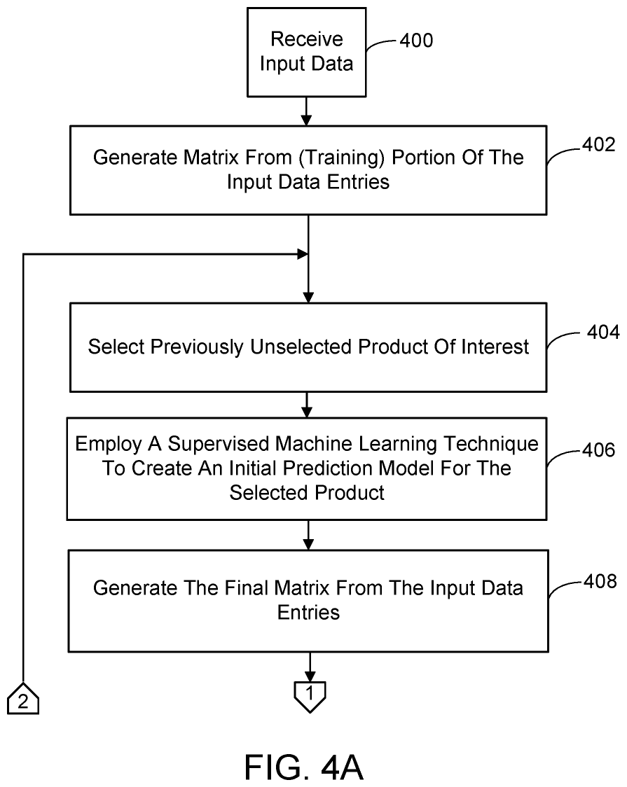

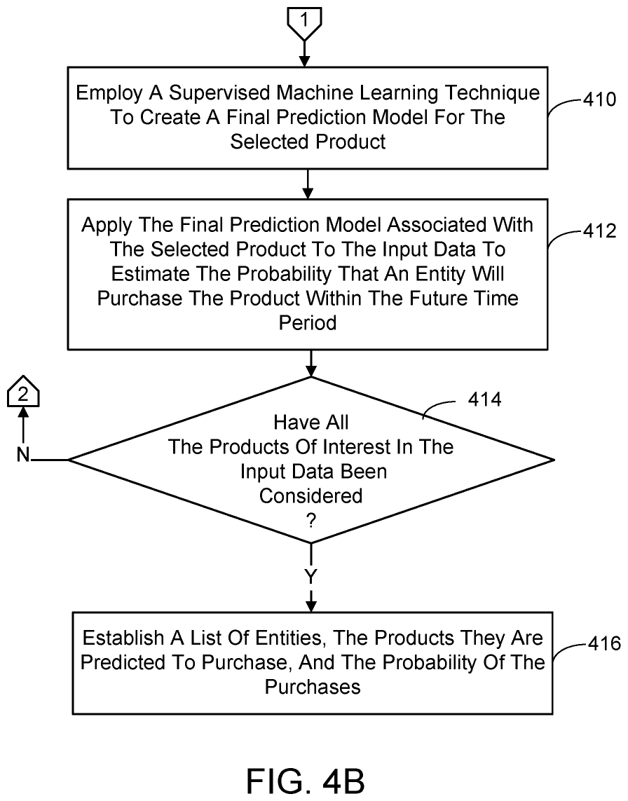

FIGS. 4A-B illustrate an exemplary implementation, in simplified form, of a process for predicting the probability that an entity will purchase a product within a future time period. In an exemplary implementation of the purchase prediction described herein, the process illustrated in FIGS. 4A-B is realized on the system framework 100 illustrated in FIG. 1. As exemplified in FIGS. 4A-B, the process starts with receiving input data in the form of entries (process action 400). As described previously, each entry includes an entity identifier, a product identifier, a time period identifier and an intensity value. The process continues with the generation of a matrix from a portion of the input data entries (process action 402). This entails assigning an entity identifier and product identifier pair associated with each interest event to a different location in the matrix, along with a time identifier indicative of how far back in time the interest event associated with each entity-product identifier pair occurred from the prescribed date of interest. A previously unselected product of interest in the input data is then selected (process action 404). A supervised machine learning technique is employed to create a prediction model for the selected product (process action 406). This generally entails using the matrix as input and creating an initial prediction model to estimate the probability that an entity in the input data will purchase the product associated with the model in the manner described previously. A final matrix is then generated from the input data entries (process action 408). This entails assigning an entity identifier and product identifier pair associated with each interest event to a different location in the matrix, along with a time identifier indicative of how far back in time the interest event associated with each entity-product identifier pair occurred from the prescribed date of interest. Next, the aforementioned supervised machine learning technique is employed to create a final prediction model for the selected product (process action 410). This entails using the final matrix as input and creating a final prediction model to estimate the probability that an entity in the input data will purchase the product associated with the model within the future time period. The last-used control parameters established in generating the initial model for the selected product are employed as the control parameters for generating the final prediction model. The final prediction model associated with the selected product is then applied to the input data to estimate the probability that an entity will purchase the product within the future time period (process action 412). It is next determined if all the products of interest in the input data have been considered and processed (process action 414). If not, process actions 404 through 414 are repeated. However, if all the products have been considered and processed, then a list of entities, the products they are predicted to purchase, and the probability of the purchases is established (process action 416). It is noted that process actions 404 through 412 can be executed serially for each product as shown in FIGS. 4A-B, or these actions can be executed in parallel for each product using multiple processors, or a combination of parallel and serial processing can be employed.

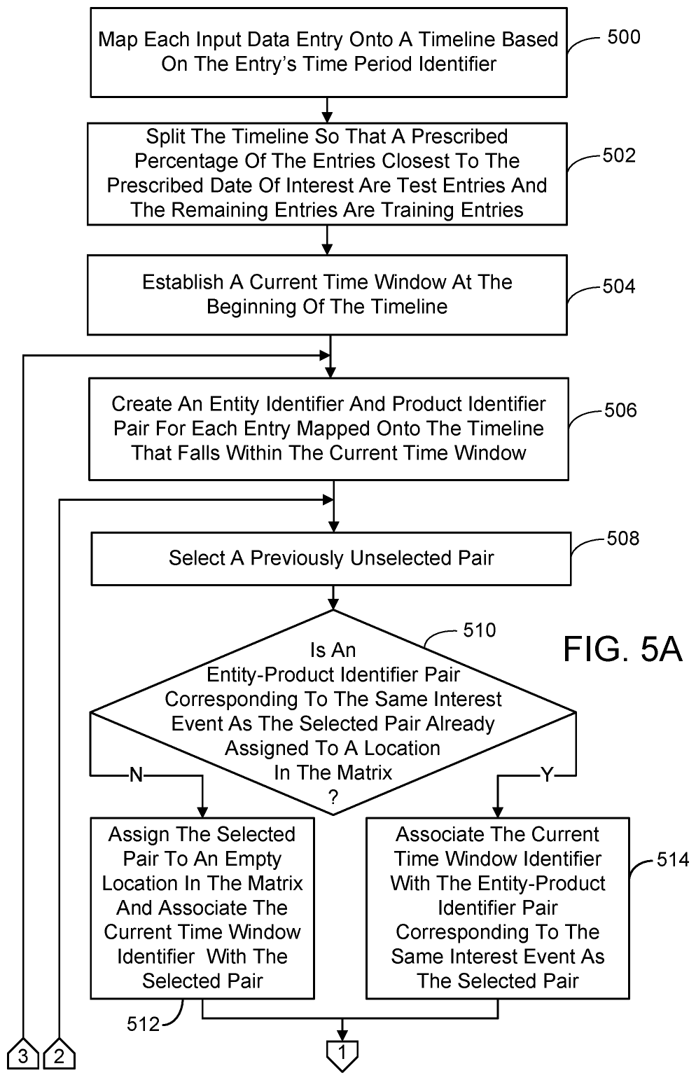

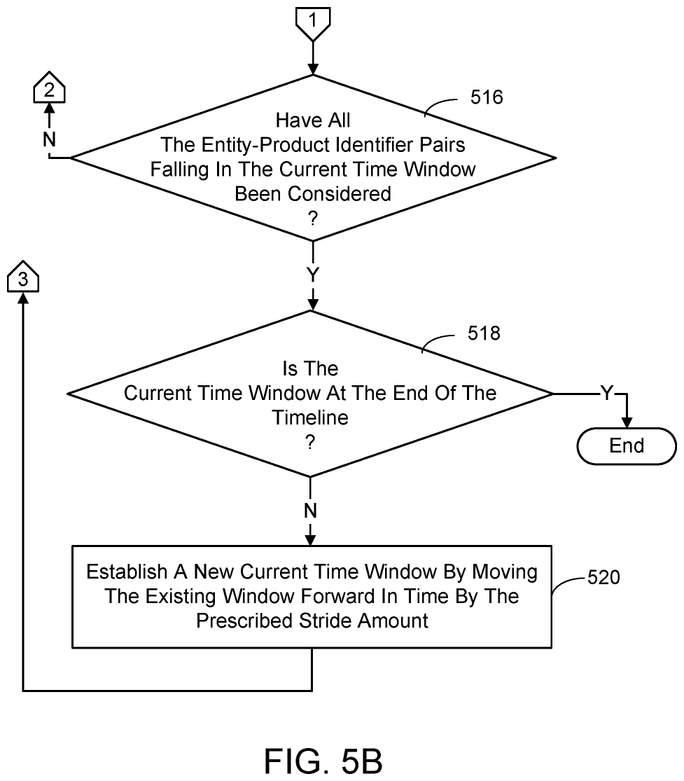

With regard to the process action for generating a matrix (402 in FIG. 4A), in one implementation this is accomplished as illustrated in FIGS. 5A-B. The process starts by mapping each input data entry onto a timeline based on the entry's time period identifier (process action 500). The timeline is then split so that a prescribed percentage of the entries closest to the prescribed date of interest are designated as test entries and the remaining entries are designated as training entries (process action 502). For the portion of the timeline comprising training entries, a time window of a prescribed size is stepped over the timeline starting with the oldest entry and moving forward in time a prescribed stride amount with each successive step. More particularly, a current time window is established starting at the beginning of the timeline (i.e., its oldest end) in process action 504. An entity identifier and product identifier pair is then created for each entry mapped onto the timeline that falls within the current time window (process action 506), and a previously unselected pair is selected (process action 508). It is then determined if an entity-product identifier pair corresponding to the same interest event as the selected pair is already assigned to a location in the matrix (process action 510). If not, the selected pair is assigned to an empty location in the matrix and a time window identifier assigned to the current time window is associated with the selected pair (process action 512). If, however, an entity-product identifier pair corresponding to the same interest event as the selected pair is already assigned to a location in the matrix, then the time window identifier assigned to the current time window is associated with the entity-product identifier pair corresponding to the same interest event as the selected pair (process action 514). Next, it is determined if all the entity-product identifier pairs falling in the current time window have been considered and processed (process action 516). If not, process actions 508 through 516 are repeated. If, however, all the entity-product identifier pairs falling in the current time window have been considered and processed, then in process action 518 it is determined if the current time window is at the end of the timeline (i.e., its newest end). If not, a new current time window is established by moving the existing window forward in time by the prescribed stride amount (process action 520), and process actions 506 through 518 are repeated. If, however, the current time window is at the end of the timeline, then the process ends.

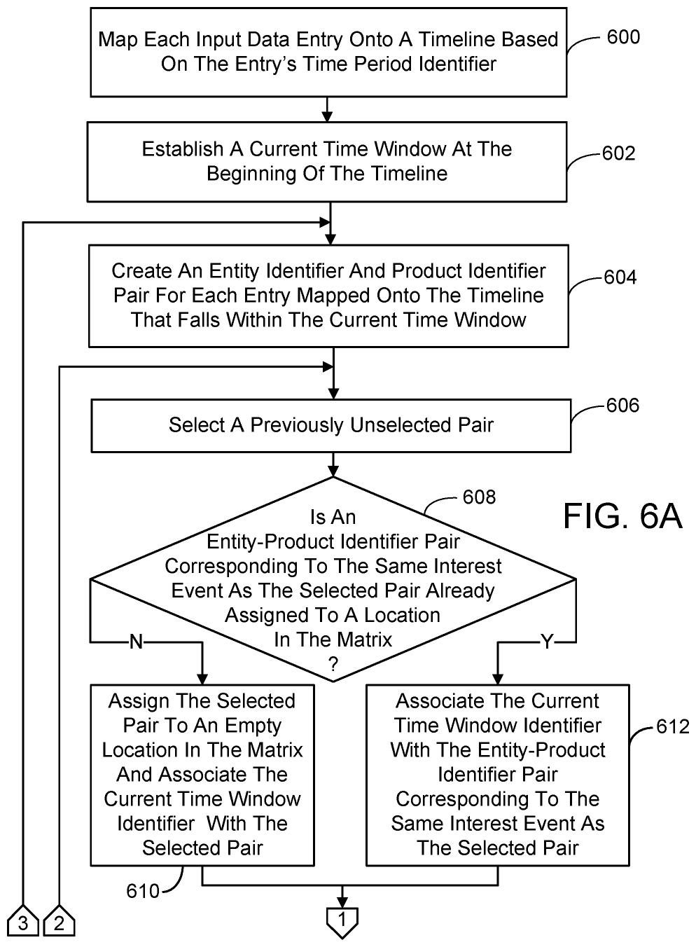

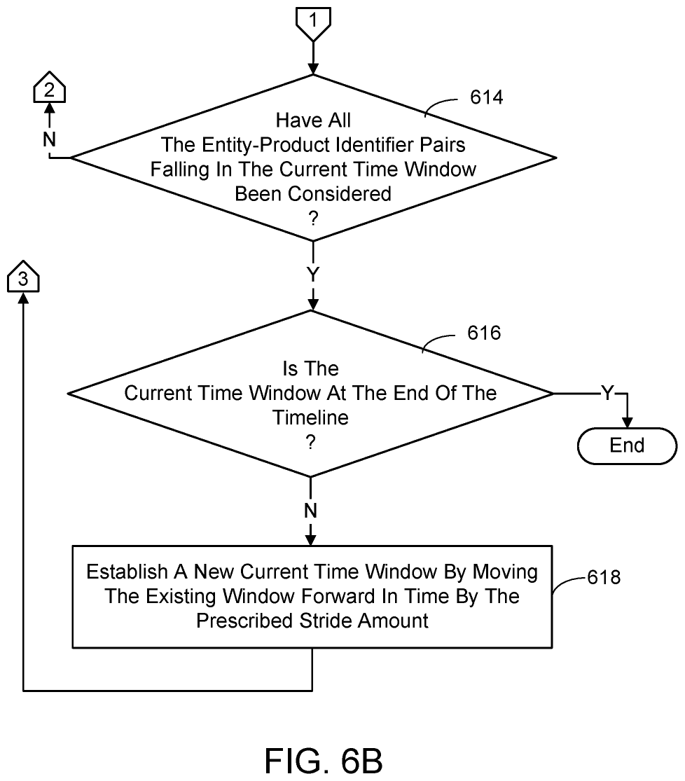

With regard to the process action for generating a final matrix (408 in FIG. 4A), in one implementation this is accomplished as illustrated in FIGS. 6A-B. The process starts by mapping each input data entry onto a timeline based on the entry's time period identifier (process action 600). A time window of a prescribed size is stepped over the timeline starting with the oldest entry and moving forward in time a prescribed stride amount with each successive step. More particularly, a current time window is established staring at the beginning of the timeline (i.e., its oldest end) in process action 602. An entity identifier and product identifier pair is then created for each entry mapped onto the timeline that falls within the current time window (process action 604), and a previously unselected pair is selected (process action 606). It is then determined if an entity-product identifier pair corresponding to the same interest event as the selected pair is already assigned to a location in the final matrix (process action 608). If not, the selected pair is assigned to an empty location in the final matrix and a time window identifier assigned to the current time window is associated with the selected pair (process action 610). If, however, an entity-product identifier pair corresponding to the same interest event as the selected pair is already assigned to a location in the final matrix, then the time window identifier assigned to the current time window is associated with the entity-product identifier pair corresponding to the same interest event as the selected pair (process action 612). Next, it is determined if all the entity-product identifier pairs falling in the current time window have been considered and processed (process action 614). If not, process actions 606 through 614 are repeated. If, however, all the entity-product identifier pairs falling in the current time window have been considered and processed, then in process action 616 it is determined if the current time window is at the end of the timeline (i.e., its newest end). If not, a new current time window is established by moving the existing window forward in time by the prescribed stride amount (process action 618), and process actions 604 through 616 are repeated. If, however, the current time window is at the end of the timeline, then the process ends.

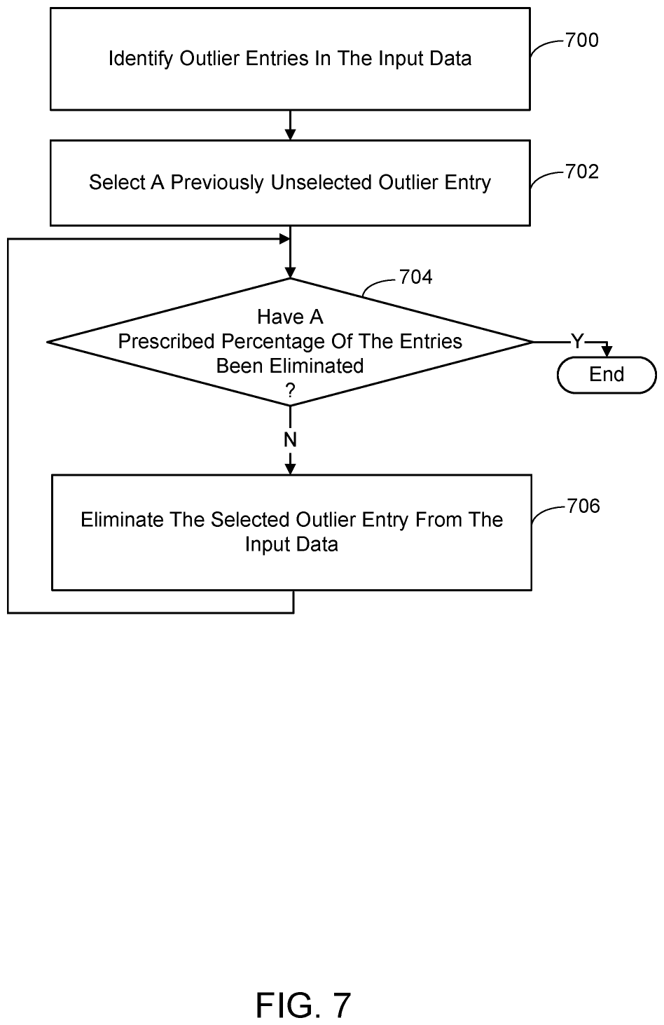

The process illustrated in FIGS. 4A-B can be modified to include process actions for eliminating the input data entries deemed likely to be inaccurate prior to generating the first matrix (402 in FIG. 4A). In one implementation, this is accomplished as illustrated in FIG. 7 by identifying outlier entries in the input data (process action 700). In one implementation, this is accomplished using a seasonal ESD test on the time period identifiers and intensity values of the input data. A previously unselected outlier entry is then selected (process action 702). It is next determined if a prescribed percentage of the input data entries have been eliminated (process action 704). If not, the selected outlier entry is eliminated from the input data (process action 706), and process actions 702 and 704 are repeated. If, however, is determined in process action 704 that the prescribed percentage of the entries have been eliminated, the process ends.

The process illustrated in FIGS. 4A-B can also be modified to include a process action for eliminating probability estimates for entities that are known to already have the product or a product in the same product category as part of generating the initial prediction model (406 in FIG. 4A). Additionally, the process illustrated in FIGS. 4A-B can also be modified to include a process action for eliminating probability estimates for entities that are known to already have the product or a product in the same product category, after applying the finalized prediction model associated with each product to the input data to estimate the probability that an entity will purchase the product within the future time period (412 in FIG. 4B).

### 2.0 Other Implementations

While the purchase predictions have been described by specific reference to implementations thereof, it is understood that variations and modifications thereof can be made without departing from the true spirit and scope.

It is further noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 3.0 Exemplary Operating Environments

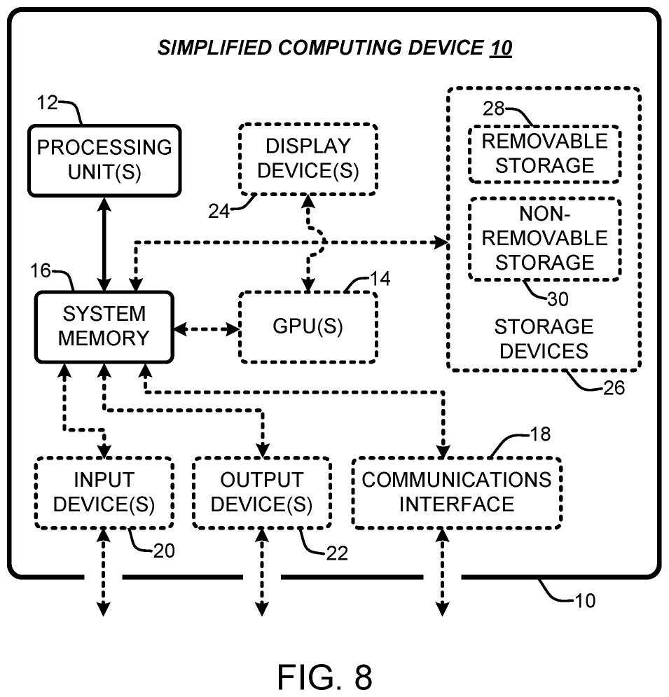

The purchase prediction implementations described herein are operational within numerous types of general purpose or special purpose computing system environments or configurations. FIG. 8 illustrates a simplified example of a general-purpose computer system on which various implementations and elements of the purchase prediction, as described herein, may be implemented. It is noted that any boxes that are represented by broken or dashed lines in the simplified computing device 10 shown in FIG. 8 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the purchase prediction implementations described herein, the device should have a sufficient computational capability and system memory to enable basic computational operations. In particular, the computational capability of the simplified computing device 10 shown in FIG. 8 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the purchase prediction implementations described herein, including input, output, control, feedback, and response to one or more users or other devices or systems associated with the purchase prediction implementations, are enabled by a variety of Natural User Interface (NUI) scenarios. The NUI techniques and scenarios enabled by the purchase prediction implementations include, but are not limited to, interface technologies that allow one or more users user to interact with the purchase prediction implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the purchase prediction implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the purchase prediction implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 8 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various purchase prediction implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The purchase prediction implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The purchase prediction implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor. Still further, the purchase prediction implementations described herein can be virtualized and realized as a virtual machine running on a computing device such as any of those described previously. In addition, multiple purchase prediction virtual machines can operate independently on the same computer device.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for predicting the probability that an entity will purchase a product within a future time period, comprising:
a purchase probability predictor comprising one or more computing devices, and a purchase probability prediction computer program having a plurality of sub-programs executable by said computing device or devices, wherein the sub-programs configure said computing device or devices to,
receive input data in the form of entries, each entry comprising,
an entity identifier that identifies an entity that is a potential purchaser of a product,
a product identifier that identifies a product that the entity associated with the entity identifier might purchase based on an interest event that is indicative of the product being relevant to the entity,
a time period identifier that specifies a past time period measured backward from a prescribed date of interest to an interest event date corresponding to the date the interest event associated with the entry occurred, and
an intensity value indicative of the degree to which the product associated with the product identifier is deemed relevant to the entity associated with the entity identifier,
generate a matrix from a portion of the input data entries, said matrix generation comprising assigning an entity identifier and product identifier pair associated with each interest event to a different location in the matrix, along with a time identifier indicative of how far back in time the interest event associated with each entity-product identifier pair occurred from the prescribed date of interest,
employ a supervised machine learning technique to create a separate initial prediction model for each product of interest in the input data that estimates the probability that an entity in the input data will purchase the product using the matrix as input,
generate a final matrix from the input data entries, said final matrix generation comprising assigning an entity identifier and product identifier pair associated with each interest event to a different location in the matrix, along with a time identifier indicative of how far back in time the interest event associated with each entity-product identifier pair occurred from the prescribed date of interest,
employ the supervised machine learning technique to create a separate final prediction model for each product of interest in the input data that estimates the probability that an entity in the input data will purchase the product within the future time period using the final matrix and control parameters established in creating the initial prediction model for each product as input;
for each product, using the input data, apply the finalized prediction model associated with that product to estimate the probability that an entity will purchase the product within the future time period; and
establish a list of entities, the products they are predicted to purchase and the probability of the purchases.

2. The system of claim 1, wherein said interest event that is indicative of the product being relevant to the entity comprises one of the entity expressing an interest in the product in a communication or a third party mentioning the entity and the product in a communication.

3. The system of claim 1, wherein the intensity value indicative of the degree to which the product associated with the product identifier is deemed relevant to the entity associated with the entity identifier in an entry comprises the number of times an interest event in the input data is associated with the same entity and product.

4. The system of claim 1, wherein the sub-program for generating a matrix from a portion of the input data entries comprises:
mapping each input data entry onto a timeline based on the entry's time period identifier;
splitting the timeline so that a prescribed percentage of the entries closest to the prescribed date of interest are designated as test entries and the remaining entries are designated as training entries; and
for the portion of the timeline comprising training entries,
stepping a time window of a prescribed size over the timeline starting at the time corresponding to the mapped entry having largest time period identifier and moving forward in time a prescribed stride amount with each successive step, and
at each step of the time window,
creating an entity identifier and product identifier pair for each entry mapped onto the timeline that falls within the current time window step, and
assigning each created pair to a different location in the matrix and associate a time window identifier assigned to the current time window step with the created pair whenever an entity identifier and product identifier pair corresponding to the same interest event as the created pair is not already assigned to a location in the matrix, and whenever an entity identifier and product identifier pair corresponding to the same interest event as the created pair is already assigned to a location in the matrix, associating a time window identifier assigned to the current time window step with the entity identifier and product identifier pair corresponding to the same interest event as the created pair.

5. The system of claim 4, wherein the sub-program for generating a matrix from a portion of the input data entries, further comprises splitting the timeline so that 30% of the entries closest to the prescribed date of interest are designated as test entries and the remaining 70% of the entries are designated as training entries.

6. The system of claim 1, wherein the sub-program for employing a supervised machine learning technique to create a separate initial prediction model for each product of interest in the input data comprises employing a logistic regression technique with elastic net regularization.

7. The system of claim 6, further comprising a sub-program for eliminating, during the creation of the initial prediction models, probability estimates for entities that are known to already have the product or a product from a same category of products as the product.

8. The system of claim 1, wherein the sub-program for generating a final matrix from the input data entries comprises:
mapping each input data entry onto a timeline based on the entry's time period identifier;
stepping a time window of a prescribed size over the timeline starting at the time corresponding to the mapped entry having largest time period identifier and moving forward in time a prescribed stride amount with each successive step, and
at each step of the time window,
creating an entity identifier and product identifier pair for each entry mapped onto the timeline that falls within the current time window step, and
assigning each created pair to a different location in the final matrix and associate a time window identifier assigned to the current time window step with the created pair whenever an entity identifier and product identifier pair corresponding to the same interest event as the created pair is not already assigned to a location in the final matrix, and whenever an entity identifier and product identifier pair corresponding to the same interest event as the created pair is already assigned to a location in the final matrix, associating a time window identifier assigned to the current time window step with the entity identifier and product identifier pair corresponding to the same interest event as the created pair.

9. The system of claim 1, further comprising a sub-program for eliminating the input data entries deemed likely to be inaccurate, prior to executing the sub-program for generating the matrix, said eliminating comprising:
identifying outlier entries in the input data using a seasonal ESD test on the time period identifiers and intensity values of the input data; and
eliminating identified outlier entries from the input data up to a prescribed percentage of the entries.

10. The system of claim 1, further comprising a sub-program for eliminating, after executing the sub-program for applying the finalized prediction model associated with each product to the input data to estimate the probability that an entity will purchase the product within the future time period, probability estimates for entities that are known to already have the product, or a product from a same category of products as the product, to establish a revised list of entities, the products they are predicted to purchase and the probability of that purchase.

11. The system of claim 1, wherein the future time period is 200 days starting from the prescribed date of interest.

12. A system for predicting the probability that an entity will purchase a product in a category of products within a future time period, comprising:
a purchase probability predictor comprising one or more computing devices, and a purchase probability prediction computer program having a plurality of sub-programs executable by said computing device or devices, wherein the sub-programs configure said computing device or devices to,
receive input data in the form of entries, each entry comprising,
an entity identifier that identifies an entity that is a potential purchaser of a product,
a product category identifier that identifies a category of products that includes a product that the entity associated with the entity identifier might purchase based on an interest event that is indicative of the product category being relevant to the entity,
a time period identifier that specifies a past time period measured backward from a prescribed date of interest to an interest event date corresponding to the date the interest event associated with the entry occurred, and
an intensity value indicative of the degree to which the product category associated with the product category identifier is deemed relevant to the entity associated with the entity identifier,
generate a matrix from a portion of the input data entries, said matrix generation comprising assigning an entity identifier and product category identifier pair associated with each interest event to a different location in the matrix, along with a time identifier indicative of how far back in time the interest event associated with each entity-product category identifier pair occurred from the prescribed date of interest,
employ a supervised machine learning technique to create a separate initial prediction model for each product category of interest in the input data that estimates the probability that an entity in the input data will purchase a product in the product category using the matrix as input,
generate a final matrix from the input data entries, said final matrix generation comprising assigning an entity identifier and product category identifier pair associated with each interest event to a different location in the matrix, along with a time identifier indicative of how far back in time the interest event associated with each entity-product category identifier pair occurred from the prescribed date of interest,
employ a supervised machine learning technique to create a separate final prediction model for each product category of interest in the input data that estimates the probability that an entity in the input data will purchase a product in the product category within the future time period using the final matrix and control parameters established in creating the initial prediction model for each product category as input,
for each product category, using the input data, apply the finalized prediction model associated with that product category to estimate the probability that an entity will purchase a product in the product category within the future time period, and
establish a list of entities, the product categories they are predicted to purchase products from and the probability of the purchases.

13. The system of claim 12, wherein said interest event that is indicative of the product category being relevant to the entry comprises one of the entity expressing an interest in a product in the product category or the product category itself in a communication or a third party mentioning the entity and a product in the product category or the product category itself in a communication.

14. The system of claim 12, wherein the sub-program for generating a matrix from a portion of the input data entries comprises:
mapping each input data entry onto a timeline based on the entry's time period identifier;
splitting the timeline so that a prescribed percentage of the entries closest to the prescribed date of interest are designated as test entries and the remaining entries are designated as training entries; and
for the portion of the timeline comprising training entries,
stepping a time window of a prescribed size over the timeline starting at the time corresponding to the mapped entry having largest time period identifier and moving forward in time a prescribed stride amount with each successive step, and
at each step of the time window,
creating an entity identifier and product category identifier pair for each entry mapped onto the timeline that falls within the current time window step, and
assigning each created pair to a different location in the matrix and associate a time window identifier assigned to the current time window step with the created pair whenever an entity identifier and product category identifier pair corresponding to the same interest event as the created pair is not already assigned to a location in the matrix, and whenever an entity identifier and product category identifier pair corresponding to the same interest event as the created pair is already assigned to a location in the matrix, associating a time window identifier assigned to the current time window step with the entity identifier and product category identifier pair corresponding to the same interest event as the created pair.

15. The system of claim 12, wherein the sub-program for employing a supervised machine learning technique to create a separate initial prediction model for each product category of interest in the input data comprises employing a logistic regression technique with elastic net regularization.

16. The system of claim 15, further comprising a sub-program for eliminating, during the executing the sub-program for creating the initial prediction models, probability estimates for entities that are known to already have a product in the associated product category.

17. The system of claim 12, wherein the sub-program for generating a final matrix from the input data entries comprises:
mapping each input data entry onto a timeline based on the entry's time period identifier;
stepping a time window of a prescribed size over the timeline starting at the time corresponding to the mapped entry having largest time period identifier and moving forward in time a prescribed stride amount with each successive step, and
at each step of the time window,
creating an entity identifier and product category identifier pair for each entry mapped onto the timeline that falls within the current time window step, and
assigning each created pair to a different location in the final matrix and associate a time window identifier assigned to the current time window step with the created pair whenever an entity identifier and product category identifier pair corresponding to the same interest event as the created pair is not already assigned to a location in the final matrix, and whenever an entity identifier and product category identifier pair corresponding to the same interest event as the created pair is already assigned to a location in the final matrix, associating a time window identifier assigned to the current time window step with the entity identifier and product category identifier pair corresponding to the same interest event as the created pair.

18. The system of claim 12, further comprising a sub-program for eliminating the input data entries deemed likely to be inaccurate, prior to executing the sub-program for generating the matrix, said eliminating comprising:
identifying outlier entries in the input data using a seasonal ESD test on the time period identifiers and intensity values of the input data; and
eliminating identified outlier entries from the input data up to a prescribed percentage of the entries.

19. The system of claim 12, further comprising a sub-program for eliminating, after executing the sub-program for applying the final prediction model associated with each product category to the input data to estimate the probability that an entity will purchase the product in the product category within the future time period, probability estimates for entities that are known to already have a product in the product category to establish a revised list of entities, the product categories they are predicted to purchase products from and the probability of that purchase.

20. A computer-implemented process for predicting the probability that an entity will purchase a product within a future time period, the process comprising the actions of:
using one or more computing devices to perform the following process actions, the computing devices being in communication with each other via a computer network whenever a plurality of computing devices is used:
receiving input data in the form of entries, each entry comprising,
an entity identifier that identifies an entity that is a potential purchaser of a product,
a product identifier that identifies a product that the entity associated with the entity identifier might purchase based on an interest event that is indicative of the product being relevant to the entity,
a time period identifier that specifies a past time period measured backward from a prescribed date of interest to an interest event date corresponding to the date the interest event associated with the entry occurred, and
an intensity value indicative of the degree to which the product associated with the product identifier is deemed relevant to the entity associated with the entity identifier;
generating a matrix from a portion of the input data entries, said matrix generation comprising assigning an entity identifier and product identifier pair associated with each interest event to a different location in the matrix, along with a time identifier indicative of how far back in time the interest event associated with each entity-product identifier pair occurred from the prescribed date of interest;
employing a supervised machine learning technique to create a separate initial prediction model for each product of interest in the input data that estimates the probability that an entity in the input data will purchase the product using the matrix as input;
generating a final matrix from the input data entries, said final matrix generation comprising assigning an entity identifier and product identifier pair associated with each interest event to a different location in the matrix, along with a time identifier indicative of how far back in time the interest event associated with each entity-product identifier pair occurred from the prescribed date of interest;
employing the supervised machine learning technique to create a separate final prediction model for each product of interest in the input data that estimates the probability that an entity in the input data will purchase the product within the future time period using the final matrix and control parameters established in creating the initial prediction model for each product as input;
for each product, using the input data, applying the final prediction model associated with that product to estimate the probability that an entity will purchase the product within the future time period; and
establishing a list of entities, the products they are predicted to purchase and the probability of the purchases.
